(19) United States
(12) Patent Application Publication
(10) Pub. No.: US 2026/0101983 A1
(43) Pub. Date: Apr. 16, 2026

(54) Protected Purse or Wallet Device

(71) Applicant: Lisa Pearson, Albany, NY (US)

(72) Inventor: Lisa Pearson, Albany, NY (US)

(21) Appl. No.: 19/339,527

(22) Filed: Sep. 25, 2025

Related U.S. Application Data
(60) Provisional application No. 63/707,985, filed on Oct. 16, 2024.

(51) Int. Cl. A45C 13/18; A45C 1/02; G07C 9/25

(52) U.S. Cl. CPC A45C 13/185; A45C 1/02; G07C 9/25

(57) ABSTRACT

A secure purse device is disclosed, which keeps purses and wallets protected using antitheft technology. The secure purse device comprises a body component that is configured in the shape of a conventional purse, wallet, or suitcase. The body component comprises a lock that opens using biometric scanning and technology, such as fingerprint identification or passcodes. The device is typically made with a lightweight, antitheft metal frame and a cloth overlay. The body component also comprises motion sensors, Wi-Fi or Bluetooth capabilities, charging ports, location tracking, etc. Each device can be controlled via a smartphone app or a smart watch, if phone access is unavailable. Users can program their devices to ensure only authorized people can gain entry to prevent financial and identity theft.

### CROSS-REFERENCE TO RELATED APPLICATION

The present application claims priority to, and the benefit of, U.S. Provisional Application No. 63/707,985, which was filed on Oct. 16, 2024, and is incorporated herein by reference in its entirety.

### FIELD OF THE INVENTION

The present invention relates generally to the field of secure purse devices. More specifically, the present invention relates to purses, pocketbooks, wallets, and other containers featuring antitheft functionalities. Accordingly, the present disclosure makes specific reference thereto. Nonetheless, it is to be appreciated that aspects of the present invention are also equally applicable to other like applications, devices and methods of manufacture.

### BACKGROUND

By way of background, this invention relates to improvements in secure purse devices. Generally, purses, wallets, suitcases, and other containers are useful for storing and carrying personal items, but these items are constantly at risk of being stolen. Further, losing a wallet can be exceptionally frustrating because there is a risk of identity theft if identity cards, debit cards, and credit cards are not canceled quickly enough. Additionally, being constantly fearful of property being stolen can cause significant anxiety.

Generally, personal belongings or important documents are typically carried along with or transported using various bags, purses, wallets, suitcases, etc. These bags are generally designed to provide a physical protection for the items they carry. However, this protection cannot provide solutions for safety issues such as theft or loss.

Accordingly, there is a demand for an improved secure purse device that features antitheft functionalities and tracking features. More particularly, there is a demand for a secure purse device that pairs wirelessly with a smartphone app or smart watch to remotely control all aspects of the device.

Therefore, there exists a long felt need in the art for a secure purse device that provides users with purses, pocketbooks, wallets, and other containers featuring antitheft functionalities. There is also a long felt need in the art for a secure purse device that prevents identity and financial theft through biometric technology like fingerprints and passcodes. Further, there is a long felt need in the art for a secure purse device that includes several other features like location tracking, alarms, motion sensors, arming and disarming capabilities, audio and video, Wi-Fi, and more to help keep personal items secure. Moreover, there is a long felt need in the art for a device that pairs wirelessly with a smartphone app or smart watch to remotely control all aspects of the device. Further, there is a long felt need in the art for a secure purse device that offers several different devices that can be equipped with these features to maintain peace of mind that personal items are safe. Finally, there is a long felt need in the art for a secure purse device that is made of a lightweight antitheft metal frame and a cloth overlay.

The subject matter disclosed and claimed herein, in one embodiment thereof, comprises a secure purse device. The device keeps purses and wallets protected using antitheft technology. The secure purse device comprises a body component that is configured in the shape of a conventional purse, wallet, or suitcase. The body component comprises a lock that opens using biometric scanning and technology, such as fingerprint identification or passcodes. The device is typically made with a lightweight, antitheft metal frame and a cloth overlay. The body component also comprises motion sensors, Wi-Fi or Bluetooth capabilities, charging ports, location tracking, etc. Each device can be controlled via a smartphone app or a smart watch, if phone access is unavailable. Users can program their devices to ensure only authorized people can gain entry to prevent financial and identity theft.

In this manner, the secure purse device of the present invention accomplishes all of the forgoing objectives and provides users with a device that features antitheft functionalities. The device is a purse, wallet, suitcase, etc. The device can pair with a smart device.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a secure purse device. The device keeps purses and wallets protected using antitheft technology. The secure purse device comprises a body component that is configured in the shape of a conventional purse, wallet, or suitcase. The body component comprises a lock that opens using biometric scanning and technology. The body component also comprises motion sensors, Wi-Fi or Bluetooth capabilities, charging ports, location tracking, etc. Each device can be controlled via a smartphone app or a smart watch, if phone access is unavailable.

In one embodiment, the secure purse device prevents identity and financial theft of a purse, wallet, suitcase, etc., via incorporating a plurality of antitheft functionalities. Losing a purse, wallet, suitcase, etc., can be frustrating and expensive. Further, being constantly fearful of having your property stolen can cause anxiety. Thus, the device allows a purse, wallet, suitcase, etc., to be equipped with the antitheft features to maintain peace of mind that personal items remain safe.

In one embodiment, the secure purse device is a smart bag which maximizes the safety of the container by virtue of the antitheft functionalities and of being paired with a mobile phone application ensuring the management of these functionalities.

In one embodiment, the secure purse device can be any suitable container as is known in the art. Specifically, the secure purse device comprises a body component that is configured in the shape of a conventional purse, wallet, suitcase, etc. Further, the body component can be configured as a large-sized suitcase or as a small-sized personal bag. It is proper for use by any age groups and can also be configured as a backpack, or have a hand-carry feature, etc.

In one embodiment, the body component is sized and shaped to securely attach to the zipper of purses, bags, and other personal belongings, etc. In this embodiment, the interior of the body component comprises any additional wirings, sensors, etc., needed for the device.

In one embodiment, the body component comprises a bottom surface and an exterior surface that provides for an open interior cavity, which can be closed and releasably secured via snaps, zippers, clasps, hook and loop fasteners, etc., or any other securing means as is known in the art.

In one embodiment, the secure purse device comprises a changeable decorative appearance. Specifically, the body component can be manufactured of various materials having decorative designs/patterns or comprises various decorative materials with any desirable color, pattern, floral decoration, fur, leather, feathers, beads, etc., or suitable ornamental design as is known in the art secured to the body component.

In one embodiment, the body component comprises a lock that opens using biometric scanning and technology, such as fingerprint identification or passcodes. Generally, biometric scanners are hardware used to capture the biometric for verification of identity. These scanners match against a saved database to approve or deny access to the device. In other words, biometric security means your body becomes the “key” to unlock your access. Biometrics are largely used because of two major benefits: convenience of use, in that biometrics are always with you and cannot be lost or forgotten. The second benefit is that they are difficult to steal or impersonate, in that biometrics can't be stolen like a password or key can. Examples of biometric security include, voice recognition, fingerprint scanning, facial recognition, iris recognition, and heart-rate sensors. In this embodiment, the biometric scanner lock is positioned on the body component, such that the biometric scanner lock acts to seal the interior cavity of the body component. Further, the biometric scanner lock allows access to the contents of the body component via scanning a user's fingerprints or can be overrode with a passcode, if needed.

In one embodiment, the biometric scanner lock with fingerprint recognition feature is disposed on the body component to seal and secure the contents within the interior cavity. In this embodiment, the biometric scanner lock is managed by means of a smart phone application or smart watch, wherein when an attempt takes place to open the device by means of a fingerprint that is not previously defined in the biometric scanner lock, a warning is transmitted to the smart phone or smart watch.

In one embodiment, the body component also comprises location tracking components, that can include a memory, a processor, a transceiver/receiver, and a GPS component. The tracking of the secure purse device is ensured by means of the GPS component, which stands for the Global Positioning System and provides a satellite-based tracking system. Typically, the GPS component of the secure purse device is managed through the smart phone application or a smart watch. After the tracking distance is determined using the application or the smart watch, the GPS tracking hardware transmits a warning to the smart phone or smart watch of the respective user when the secure purse device is brought out of a predetermined tracking distance.

In one embodiment, the body component comprises motion sensors to detect the unauthorized movement of the secure purse device. Any suitable motion sensor can be utilized as is known in the art.

In one embodiment, the body component comprises an alarm with arming and disarming capabilities in communication with a camera and microphone/speaker for audio and video notifications, as well. The alarm can be any suitable alarm as is known in the art. Typically, the alarm, camera, and microphone/speaker are in communication with the processor, allowing a user to arm and disarm the alarm, as needed. Further, in one embodiment, the alarm is managed by means of a smart phone application or smart watch, wherein when an attempt takes place to remove the device and/or the device is attempted to be opened by an unauthorized person, a warning is transmitted to the smart phone or smart watch.

In one embodiment, the body component comprises Wi-Fi or Bluetooth capabilities. Specifically, the transceiver/receiver allows for the Wi-Fi or Bluetooth capabilities for connection to smart devices and smart watches.

In one embodiment, the body component and its components are powered by a battery. The battery can be replaceable or rechargeable. If rechargeable, the body component comprises a charging port for charging the rechargeable battery, as needed.

In one embodiment, each device can be controlled via a smartphone app or a smart watch, if phone access is unavailable. Thus, users can program their devices to ensure only authorized people can gain entry to prevent financial and identity theft. Specifically, the secure purse device includes a wireless communications module and additional sensors which would allow the device to pair with a mobile application on a smart device. Once paired, a user could control the secure purse device via the mobile application or smart watch.

In one embodiment, the secure purse device is manufactured from a lightweight antitheft metal frame, such as titanium, aluminum, or magnesium, etc., with a cloth overlay, such as cotton, nylon, polyester, rayon, etc., or other suitable materials as is known in the art, or a combination of such materials.

In yet another embodiment, the secure purse device comprises a plurality of indicia.

In yet another embodiment, a method of preventing identity and financial theft for a purse or other container is disclosed. The method includes the steps of providing a secure purse device comprising a body component with antitheft components. The method also comprises utilizing biometric technology to lock the device, such as fingerprint scans or passcodes. Further, the method comprises utilizing location tracking and motion sensors to prevent theft and track the device, if needed. The method also comprises controlling the device via a smartphone app or a smart watch. The method comprises programming the device to ensure only authorized people can gain entry. Finally, the method comprises manufacturing the device of a lightweight, antitheft metal frame and a cloth overlay.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one embodiment of the secure purse device of the present invention in accordance with the disclosed architecture;

FIG. 1A illustrates a perspective view of one embodiment of the secure purse device of the present invention wherein the body component is sized and shaped to be secured to a zipper of a purse or bag in accordance with the disclosed architecture;

FIG. 2 illustrates a perspective view of one embodiment of the secure purse device of the present invention showing the device paired with a smart watch in accordance with the disclosed architecture;

FIGS. 3A-B illustrate a perspective view of one embodiment of the secure purse device of the present invention showing the biometric system in use on the device in accordance with the disclosed architecture;

FIG. 4 illustrates a perspective view of one embodiment of the secure purse device of the present invention showing the device and its components in accordance with the disclosed architecture;

FIG. 5 illustrates a flowchart showing the method of preventing identity and financial theft for a purse or other container in accordance with the disclosed architecture; and

FIG. 6 illustrates a perspective view of the device schematics in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for a secure purse device that provides users with purses, pocketbooks, wallets, and other containers featuring antitheft functionalities. There is also a long felt need in the art for a secure purse device that prevents identity and financial theft through biometric technology like fingerprints and passcodes. Further, there is a long felt need in the art for a secure purse device that includes several other features like location tracking, alarms, motion sensors, arming and disarming capabilities, audio and video, Wi-Fi, and more to help keep personal items secure. Moreover, there is a long felt need in the art for a device that pairs wirelessly with a smartphone app or smart watch to remotely control all aspects of the device. Further, there is a long felt need in the art for a secure purse device that offers several different devices that can be equipped with these features to maintain peace of mind that personal items are safe. Finally, there is a long felt need in the art for a secure purse device that is made of a lightweight antitheft metal frame and a cloth overlay.

The present invention, in one exemplary embodiment, is a novel secure purse device. The secure purse device comprises a body component that is configured in the shape of a conventional purse, wallet, or suitcase. The body component comprises a lock that opens using biometric scanning and technology, such as fingerprint identification or passcodes. The body component also comprises motion sensors, Wi-Fi or Bluetooth capabilities, charging ports, location tracking, etc. Each device can be controlled via a smartphone app or a smart watch, if phone access is unavailable. The present invention also includes a novel method of preventing identity and financial theft for a purse or other container. The method includes the steps of providing a secure purse device comprising a body component with antitheft components. The method also comprises utilizing biometric technology to lock the device, such as fingerprint scans or passcodes. Further, the method comprises utilizing location tracking and motion sensors to prevent theft and track the device, if needed. The method also comprises controlling the device via a smartphone app or a smart watch. The method comprises programming the device to ensure only authorized people can gain entry. Finally, the method comprises manufacturing the device of a lightweight, antitheft metal frame and a cloth overlay.

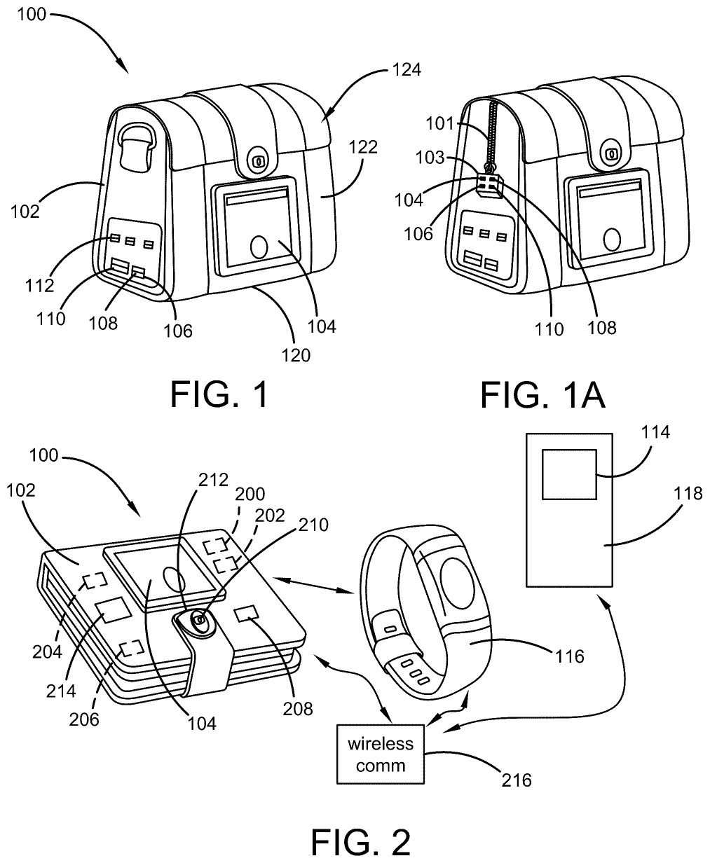

Referring initially to the drawings, FIG. 1 illustrates a perspective view of one embodiment of the secure purse device 100 of the present invention. In the present embodiment, the secure purse device 100 is an improved secure purse device 100 that provides a user with a container equipped with antitheft technology. Specifically, the secure purse device 100 comprises a body component 102 with a plurality of antitheft components. The secure purse device 100 comprises a body component 102 that is configured in the shape of a conventional purse, wallet, or suitcase. The body component 102 comprises a lock 104 that opens using biometric scanning and technology. The body component 102 also comprises motion sensors 106, Wi-Fi or Bluetooth capabilities 108, charging ports 110, location tracking 112, etc. Each device 100 can be controlled via a smartphone app 114 or a smart watch 116, if smart phone 118 access is unavailable.

Generally, the secure purse device 100 prevents identity and financial theft of a purse, wallet, suitcase, etc., via incorporating a plurality of antitheft functionalities. Losing a purse, wallet, suitcase, etc., can be frustrating and expensive. Further, being constantly fearful of having your property stolen can cause anxiety. Thus, the device 100 allows a purse, wallet, suitcase, etc., to be equipped with the antitheft features to maintain peace of mind that personal items remain safe.

Typically, the secure purse device 100 is a smart bag which maximizes the safety of the container by virtue of the antitheft functionalities and of being paired with a mobile phone application 114 ensuring the management of these functionalities.

Further, the secure purse device 100 can be any suitable container as is known in the art. Specifically, the secure purse device 100 comprises a body component 102 that is configured in the shape of a conventional purse, wallet, suitcase, etc. Further, the body component 102 can be configured as a large-sized suitcase or as a small-sized personal bag, and is available in multiple sizes and shapes as is known in the art. It is proper for use by any age groups and can also be configured as a backpack, or have a hand-carry feature, etc.

As shown in FIG. 1A, in one embodiment, the body component 103 is sized and shaped to securely attach to the zipper 101 of purses, bags, and other personal belongings, etc. In this embodiment, the interior of the body component 103 comprises any additional wirings, sensors, etc., needed for the device 100.

Additionally, the body component 102 comprises a bottom surface 120 and an exterior surface 122 that provides for an open interior cavity 124, which can be closed and releasably secured via snaps, zippers, clasps, hook and loop fasteners, etc., or any other securing means as is known in the art.

As shown in FIG. 2, the body component 102 also comprises location tracking components 112, that can include a memory 200, a processor 202, a transceiver/receiver 204, and a GPS component 206. The tracking of the secure purse device 100 is ensured by means of the GPS component 206, which stands for the Global Positioning System and provides a satellite-based tracking system. Typically, the GPS component 206 of the secure purse device 100 is managed through the smart phone application 114 or a smart watch 116. After the tracking distance is determined using the application 114 or the smart watch 116, the GPS tracking hardware 206 transmits a warning to the smart phone 118 or smart watch 116 of the respective user when the secure purse device 100 is brought out of a predetermined tracking distance.

Further, in one embodiment, the body component 102 comprises motion sensors 106 to detect the unauthorized movement of the secure purse device 100. Any suitable motion sensor 106 can be utilized as is known in the art. Further, the motion sensor 106 can be managed by means of a smart phone application 114 on a smart device 118 or a smart watch 116, wherein when motion is detected, a warning is transmitted to the smart phone 118 or smart watch 116.

Additionally, in one embodiment, the body component 102 comprises an alarm 208 with arming and disarming capabilities in communication with a camera 210 and microphone/speaker 212 for audio and video notifications, as well. The alarm 208 can be any suitable alarm as is known in the art. Typically, the alarm 208, camera 210, and microphone/speaker 212 are in communication with the processor 202, allowing a user to arm and disarm the alarm 208, as needed. Further, in one embodiment, the alarm 208 is managed by means of a smart phone application 114 or smart watch 116, wherein when an attempt takes place to remove the device 100 and/or the device 100 is attempted to be opened by an unauthorized person, a warning is transmitted to the smart phone 118 or smart watch 116.

Typically, the body component 102 comprises Wi-Fi or Bluetooth capabilities 108. Specifically, the transceiver/receiver 204 allows for the Wi-Fi or Bluetooth capabilities 108 for connection to smart devices 118 and smart watches 116. Any suitable Wi-Fi or Bluetooth capabilities 108 can be utilized as is known in the art.

Further, the body component 102 and its components are powered by a battery 214. The battery 214 can be replaceable or rechargeable. If rechargeable, the body component 214 comprises a charging port 110 for charging the rechargeable battery 214, as needed.

The battery 214 may be a disposable battery or a rechargeable battery in the form of an alkaline, nickel-cadmium, nickel-metal hydride battery, etc., such as any 3V-12volts DC battery or other conventional battery, such as A, AA, AAA, etc., that supplies power to the secure purse device 100. Throughout this specification, the term “battery” may be used interchangeably to refer to one or more wet or dry cells or batteries of cells in which chemical energy is converted into electricity and used as a source of DC power. References to recharging or replacing the battery 214 may refer to recharging or replacing individual cells, individual batteries of cells, or a package of multiple battery cells as is appropriate for any given battery technology that may be used. In addition, a rechargeable embodiment of the battery 214 may be recharged using a USB port 110, wherein the USB port 110 is a USB-A, USB-B, Micro-B, Micro-USB, Mini-USB, or USB-C port, etc.

Additionally, the secure purse device 100 can be controlled via a smartphone app 114 or a smart watch 116, if phone 118 access is unavailable. Thus, users can program their devices 100 to ensure only authorized people can gain entry to prevent financial and identity theft. Specifically, the secure purse device 100 includes a wireless communications module 216 and additional sensors which would allow the device 100 to pair with a mobile application 114 on a smart device 118. Once paired, a user could control the secure purse device 100 via the mobile application 114 or smart watch 116. The mobile or smart device 118 may perform any type of wireless communication, including, but not limited to, WIFI, BLUETOOTH, RFID, NFC, etc. As such, the user may use a mobile or smart device 118 to input and/or program the antitheft components to receive alerts via the smart phone 118 or smart watch 116.

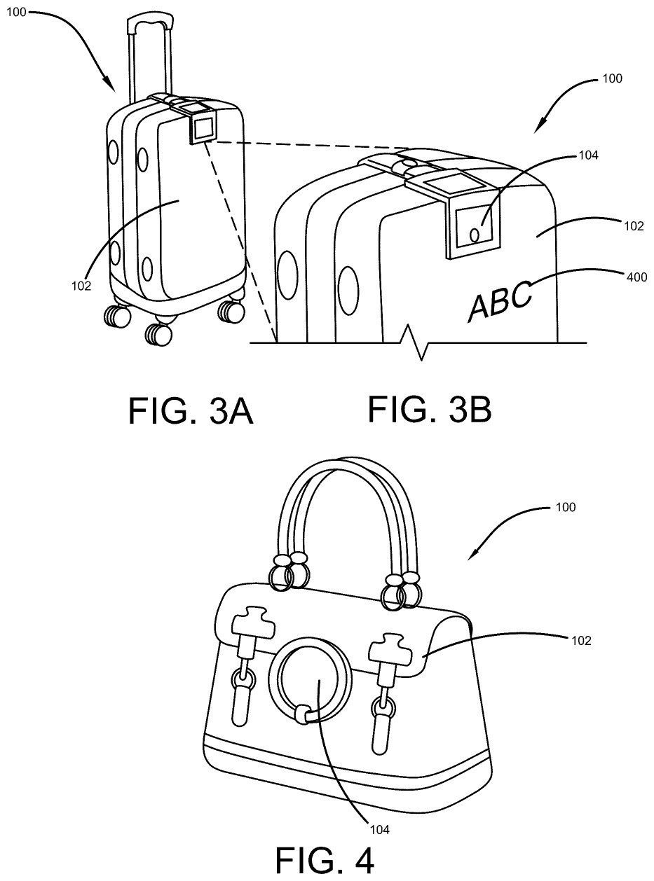

As shown in FIGS. 3A-B, the body component 102 comprises a lock 104 that opens using biometric scanning and technology, such as fingerprint identification or passcodes. Generally, biometric scanners are hardware used to capture the biometric for verification of identity. These scanners match against a saved database to approve or deny access to the device 100. In other words, biometric security means your body becomes the “key” to unlock your access. Biometrics are largely used because of two major benefits: convenience of use, in that biometrics are always with you and cannot be lost or forgotten. The second benefit is that they are difficult to steal or impersonate, in that biometrics can't be stolen like a password or key can. Examples of biometric security include, voice recognition, fingerprint scanning, facial recognition, iris recognition, and heart-rate sensors. In this embodiment, the biometric scanner lock 104 is positioned on the body component 102, such that the biometric scanner lock 104 acts to seal the interior cavity 124 of the body component 102. Further, the biometric scanner lock 104 allows access to the contents of the body component 102 via scanning a user's fingerprints or can be overrode with a passcode, if needed.

Generally, the biometric scanner lock 104 with fingerprint recognition feature is disposed on the body component 102 to seal and secure the contents within the interior cavity 124. In this embodiment, the biometric scanner lock 104 is managed by means of a smart phone application 114 or smart watch 116, wherein when an attempt takes place to open the device 100 by means of a fingerprint that is not previously defined in the biometric scanner lock 104, a warning is transmitted to the smart phone 118 or smart watch 116.

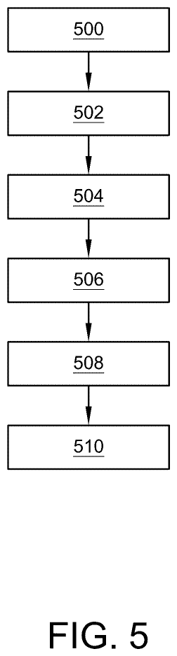

As shown in FIG. 4, the secure purse device 100 comprises a changeable decorative appearance. Specifically, the body component 102 can be manufactured of various materials having decorative designs/patterns or comprises various decorative materials with any desirable color, pattern, floral decoration, fur, leather, feathers, beads, etc., or suitable ornamental design as is known in the art secured to the body component 102.

In one embodiment, the secure purse device 100 is manufactured from a lightweight antitheft metal frame, such as titanium, aluminum, or magnesium, etc., with a cloth overlay, such as cotton, nylon, polyester, rayon, etc., or other suitable materials as is known in the art, or a combination of such materials.

In yet another embodiment, the secure purse device 100 comprises a plurality of indicia 400. The body component 102 of the device 100 may include advertising, a trademark, or other letters, designs, or characters, printed, painted, stamped, or integrated into the body component 102, or any other indicia 400 as is known in the art. Specifically, any suitable indicia 400 as is known in the art can be included, such as but not limited to, patterns, logos, emblems, images, symbols, designs, letters, words, characters, animals, advertisements, brands, etc., that may or may not be purse, wallet, or brand related.

FIG. 5 illustrates a flowchart of the method of preventing identity and financial theft for a purse or other container. The method includes the steps of at 500, providing a secure purse device comprising a body component with antitheft components. The method also comprises at 502, utilizing biometric technology to lock the device, such as fingerprint scans or passcodes. Further, the method comprises at 504, utilizing location tracking and motion sensors to prevent theft and track the device, if needed. The method also comprises at 506, controlling the device via a smartphone app or a smart watch. The method comprises at 508, programming the device to ensure only authorized people can gain entry. Finally, the method comprises at 510, manufacturing the device of a lightweight, antitheft metal frame and a cloth overlay.

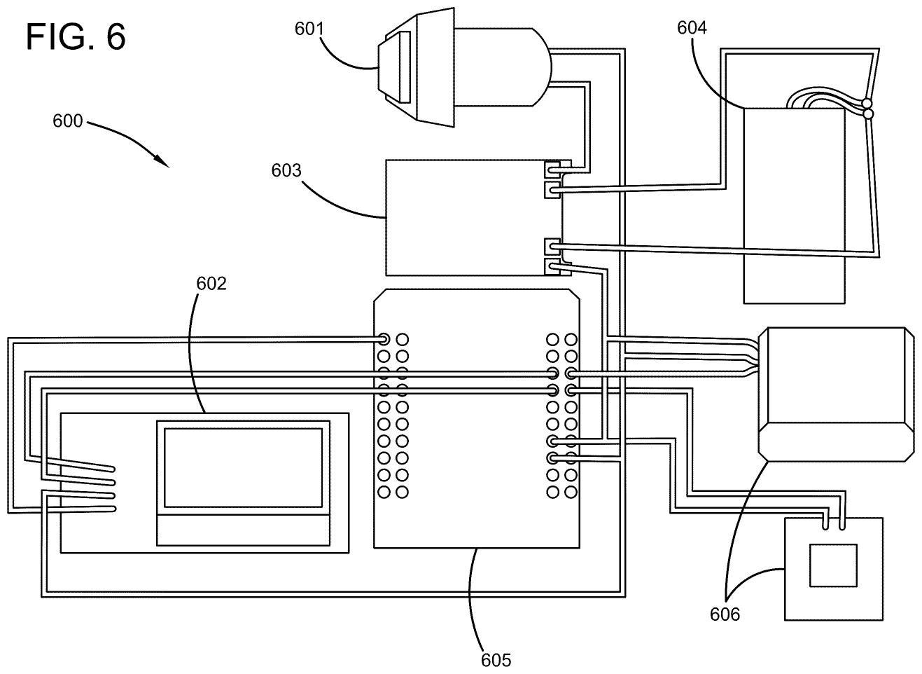

FIG. 6 illustrates the device schematics 600 for use, wherein the device 100 further comprises an on/off button 601, a supply chip 602, a charging port 603, a battery 604, a main board 605 and a lock/unlock motor 606.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “secure purse device”, “purse device”, and “device” are interchangeable and refer to the secure purse device 100 of the present invention.

Notwithstanding the forgoing, the secure purse device 100 of the present invention can be of any suitable size and configuration as is known in the art without affecting the overall concept of the invention, provided that it accomplishes the above stated objectives. One of ordinary skill in the art will appreciate that the secure purse device 100 as shown in FIGS. 1-5 is for illustrative purposes only, and that many other sizes and shapes of the secure purse device 100 are well within the scope of the present disclosure. Although the dimensions of the secure purse device 100 are important design parameters for user convenience, the secure purse device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A secure purse device that provides a container equipped with antitheft technology, the secure purse device comprising:
a body component configured to be secured to a conventional purse, a wallet, or a suitcase;
wherein the body component comprises a plurality of antitheft components, such as a biometric scanner lock, a location tracking component, a motion sensor, or an alarm; and
further wherein the secure purse device prevents identity and financial theft of a user's personal belongings housed within the body component.

2. The secure purse device of claim 1, wherein the body component is secured to a zipper of the conventional purse, wallet or suitcase.

3. The secure purse device of claim 2, wherein the body component comprises a memory, a processor, a transceiver/receiver, and a GPS component for tracking.

4. The secure purse device of claim 3, wherein the alarm has arming and disarming capabilities and is in communication with a camera and microphone/speaker for audio and video notifications.

5. The secure purse device of claim 4, wherein the body component comprises Wi-Fi or Bluetooth capabilities.

6. The secure purse device of claim 5, wherein the body component comprises and is powered by a rechargeable battery.

7. The secure purse device of claim 6, wherein the body component comprises a charging port for charging the rechargeable battery, as needed.

8. The secure purse device of claim 7, wherein the secure purse device can be controlled via a smartphone application on a smart device or via a smart watch.

9. The secure purse device of claim 8, wherein the secure purse device includes a wireless communications module and additional sensors which would allow the secure purse device to pair with the smartphone application on the smart device or the smart watch.

10. The secure purse device of claim 9, wherein once paired, a user could control the secure purse device via the smartphone application or the smart watch to program alerts.

11. The secure purse device of claim 10, wherein the biometric scanner lock acts to seal the open interior cavity of the body component and allows access to contents of the body component via scanning a user's fingerprints or can be overrode with a passcode, if needed.

12. A secure purse device that provides a container equipped with antitheft technology, the secure purse device comprising:
a body component configured as a conventional purse, wallet, or suitcase;
wherein the body component comprises a bottom surface and an exterior surface that provides for an open interior cavity, which can be closed and releasably secured via snaps, zippers, clasps, or hook and loop fasteners;
wherein the body component comprises a memory, a processor, a transceiver/receiver, and a GPS component for tracking;
wherein the body component comprises a plurality of antitheft components, such as a biometric scanner lock, a location tracking component, a motion sensor, or an alarm;
wherein the alarm has arming and disarming capabilities and is in communication with a camera and microphone/speaker for audio and video notifications;
wherein the body component comprises Wi-Fi or Bluetooth capabilities;
wherein the biometric scanner lock acts to seal the open interior cavity of the body component and allows access to contents of the body component via scanning a user's fingerprints or can be overrode with a passcode, if needed; and
further wherein the secure purse device prevents identity and financial theft of a user's personal belongings housed within the body component.

13. The secure purse device of claim 12, wherein the body component comprises and is powered by a rechargeable battery.

14. The secure purse device of claim 13, wherein the body component comprises a charging port for charging the rechargeable battery, as needed.

15. The secure purse device of claim 12, wherein the secure purse device can be controlled via a smartphone application on a smart device or via a smart watch.

16. The secure purse device of claim 12, wherein the body component comprises a changeable decorative appearance.

17. The secure purse device of claim 16, wherein the body component can be manufactured of various materials having decorative designs or patterns or comprises various decorative materials.

18. The secure purse device of claim 12, wherein the body component is manufactured from a lightweight antitheft metal frame, such as titanium, aluminum, or magnesium, with a cloth overlay, such as cotton, nylon, polyester, or rayon.

19. The secure purse device of claim 12 further comprising a plurality of indicia.

20. A method of preventing identity and financial theft for a purse or other container, the method comprising the following steps:
providing a secure purse device comprising a body component with antitheft components;
utilizing biometric technology to lock the device, such as fingerprint scans or passcodes; utilizing location tracking and motion sensors to prevent theft and track the device, if needed;
controlling the device via a smartphone app or a smart watch;
programming the device to ensure only authorized people can gain entry; and
manufacturing the device of a lightweight, antitheft metal frame and a cloth overlay.
